(19) United States
(12) Patent Application Publication
(10) Pub. No.: US 2007/0289947 A1
(43) Pub. Date: Dec. 20, 2007

(54) Method for polishing lithium aluminum oxide crystal

(75) Inventors: Mitch M. C. Chou, Chiayi City (TW); Wen-Ching Hsu, Hsinchu City (TW); Chi-Tse Lee, Hsinchu City (TW); Sin-Jie Huang, Kaohsiung City (TW)

Correspondence Address: TROXELL LAW OFFICE PLLC, 5205 LEESBURG PIKE, SUITE 1404, FALLS CHURCH, VA, 22041, US

(73) Assignees: National Sun Yat-sen University, Kaohsiung City (TW); Sino American Silicon Products Inc., Hsinchu City (TW)

(21) Appl. No.: 11/454,005

(22) Filed: Jun. 16, 2006

(51) Int. Cl. C03C 15/00

(52) U.S. Cl. 216/89

(57) ABSTRACT

The present invention polishes a lithium aluminum oxide (LiAlo₂) crystal several times with three different materials and then the LiAlo₂ crystal are soaked into an acid solution to be washed for obtaining a LiAlo₂ crystal of film-free, scratch-free with smooth surface.

### FIELD OF THE INVENTION

The present invention relates to a method for polishing a crystal; more particularly, relates to obtaining a smooth surface of a film-free and scratch-free lithium aluminum oxide crystal with a roughness below 1.0 nanometer (nm) root-mean square (rms).

### DESCRIPTION OF THE RELATED ART

GaN-based nitride semiconductors not only have wide bandgaps (1.2˜6.2 eV) but also are grown epitaxially over a number of substrates.

For a heteroepitaxy, the quality of GaN film lies much on the properties of substrate—both the inherent properties, such as lattice constants and thermal expansion coefficients; and process induced properties, such as surface roughness, step height, terrace width and wetting behavior. Thus, substrates capable of supporting better quality GaN epitaxial layers are in need of realizing the full potential of GaN-based devices.

It is particularly surprising at present that sapphire still remains as the most common choice for GaN-based LEDs. Nevertheless, its structure is unsuitable to be chosen as a substrate for epitaxy according to general assumptions. It has large lattice constant (˜15%) mismatch and thermal expansion coefficient mismatches with GaN. Besides, the sapphire substrate has a roughness typically between 0.8 and 2.1 nm rms over 1 mm². Hence, the prior art does not fulfill users' requests on actual use.

### SUMMARY OF THE INVENTION

The main purpose of the present invention is to obtain a film-free and scratch-free LiAlO₂ crystal having a roughness below 1.0 nm rms.

To achieve the above purpose, the present invention is a method for polishing LiAlO₂ crystal, where a LiAlO₂ crystal is polished on a surface by using siliconcarbides having various size of grains for the first time; Al₂O₃ powders (having various size of grains) mixed with deionized water for the second time; and a colloidal silica suspension for the third time; and then the LiAlO₂ crystal obtained after the polishings is soaked into a phosphoric acid (H₃PO₄) solution for etching to obtain a smooth surface of the LiAlO₂ crystal having a roughness below 1.0 nm rms. Accordingly, a novel method for polishing lithium aluminum oxide crystal is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a view showing a work flow according to a preferred embodiment of the present invention;

FIG. 2 is a view showing a first polishing according to the preferred embodiment of the present invention;

FIG. 3 is a view showing a second polishing according to the preferred embodiment of the present invention;

FIG. 4 is a view showing a third polishing according to the preferred embodiment of the present invention; and

FIG. 5 is a view showing a washing according to the preferred embodiment of the present invention.

### DESCRIPTION OF THE PREFERRED EMBODIMENT

The following description of the preferred embodiment is provided to understand the features and the structures of the present invention.

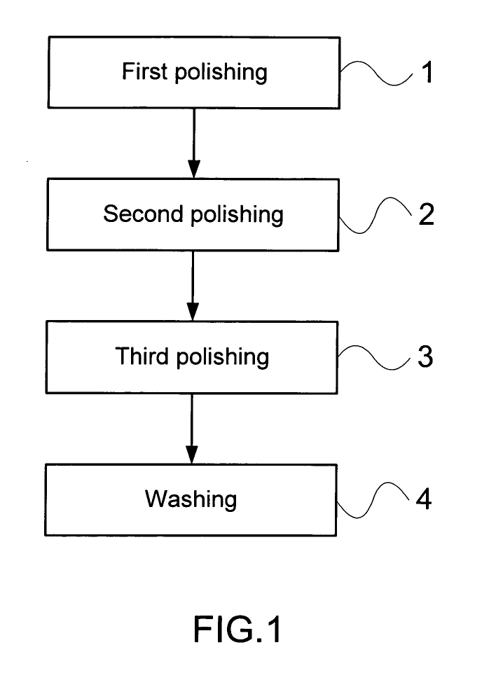

Please refer to FIG. 1, which is a view showing a work flow according to a preferred embodiment of the present invention. As shown in the figure, the present invention is a method for polishing a lithium aluminum oxide (LiAlO₂) crystal, comprising the following steps:

Step 1—First polishing: A LiAlO₂ crystal is obtained to be polished on a surface of the LiAlO₂ crystal for the first time 1 by sequentially using four silicon carbides of four respective grain-size sequences, coordinated with a water.

Step 2—Second polishing: After some aluminum oxide (Al₂O₃) powders having various grain sizes of Al₂O₃ are mixed with deionized waters to obtain Al₂O₃ powder solutions, the LiAlO₂ crystal is polished on the surface for the second time 2 by a grinder/polisher machine coordinated with the Al₂O₃ powder solutions.

Step 3—Third polishing: The LiAlO₂ crystal is polished on the surface for the third time 3 by the grinder/polisher machine coordinated with a colloidal silica (SiO₂) suspension.

And, Step 4—Washing: The LiAlO₂ crystal is soaked into a phosphoric (H₃PO₄) acid solution at a room temperature, and then the LiAlO₂ crystal is washed with an acetone followed with a deionized water to be washed away contaminations on the surface.

Through the above steps, a roughness between 0.4 and 0.9 nanometer (nm) root-mean square (rms) for the surface of the LiAlO₂ crystal is obtained. Thus, a novel method for polishing LiAlO₂ crystal is obtained.

The steps of the method for polishing LiAlO₂ crystal according to the present invention are shown in FIG. 1; and the followings are the detailed implementation descrptions of the steps.

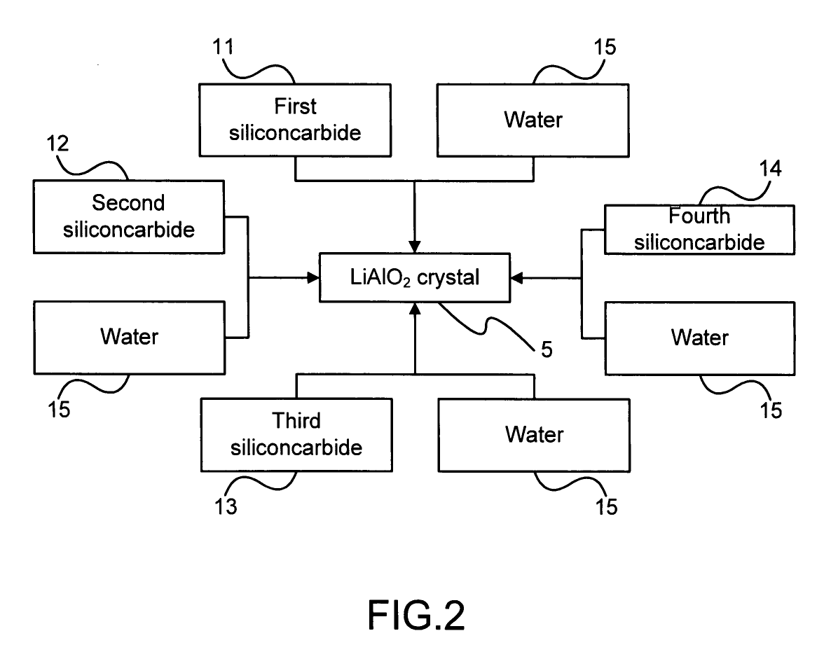

Please further refer to FIG. 2, which is a view showing the first polishing according to the preferred embodiment of the present invention. As shown in the figure, in the first polishing 1, a LiAlO₂ crystal 5 is obtained to be polished on a surface for the first time 1 by sequentially using a first siliconcarbide 11 of grain-size sequence 800, a second siliconcarbide 12 of grain-size sequence 1000, a third silicon carbide 13 of grain-size sequence 2000, and a fourth siliconcarbide 14 of grain-size sequence 4000, coordinated with a water 15. A time for each polishing using one of the siliconcarbides is between 40 and 50 minutes (min). Therein, after polishing with the second silicon carbide 12 of grain-size sequence 1000, the surface is examined with naked eyes to find scratch if there is any. It is because a scratch made dunring a polishing by the second silicon carbide 12 of grain-size sequence 1000 can not be eliminated by the polishing using the third siliconcarbide 13 of grain-size sequence 2000. Moreover, each of the directions for the polishings using the siliconcarbides are continuously changed to prevent from leaving scratch.

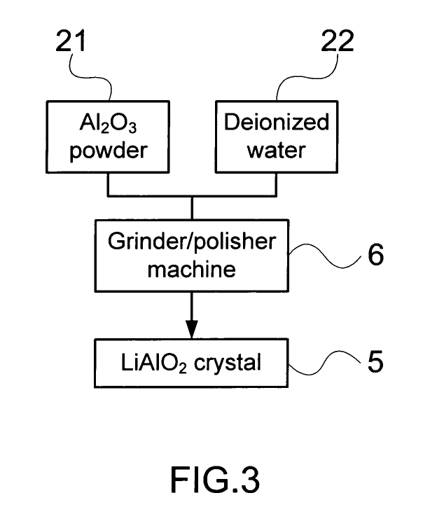

Please further refer to FIG. 3, which is a view showing the second polishing according to the preferred embodiment of the present invention. As shown in the figure, in the second polishing 2, various Al₂O₃ powders 21 having various sizes of 1 micrometer (μm), 0.3 μm and 0.05 μm respectively are mixed with a deionized water 22. Then the grinder/polisher machine 6 is used to polish the LiAlO₂ crystal 5 on the surface for the second time 2 with a rotation speed of 150 to 200 revolutions per minute (rpm). The polishings which are fone by using the Al₂O₃ powder solutions 21 having various grain sizes of Al₂O₃ spend time about 30 to 40 min for each polishing. In addition, directions for the polishings are continuously changed to prevent from any scratch.

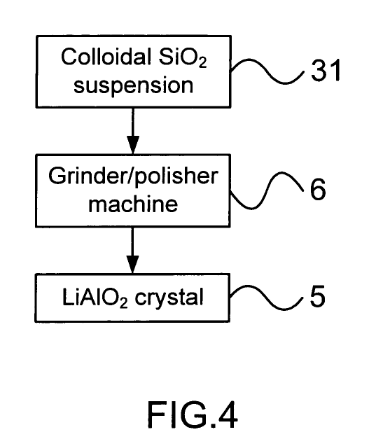

Please further refer to FIG. 4, which is a view showing the third polishing according to the preferred embodiment of the present invention. As shown in the figure, in the third polishing 3, the grinder/polisher machine 6 polishes the LiAlO₂ crystal 5 on the surface with a polishing fabric for the third time 3 coordinated with a colloidal silica (SiO₂) suspension 31 having a grain size of 0.04 μm (produced by Precision Surfaces International Co.) under a rotation speed of 150 to 200 rpm. A time spent for the polishing is about 20 to 30 min. In addition, a direction for the polishing is continuously changed.

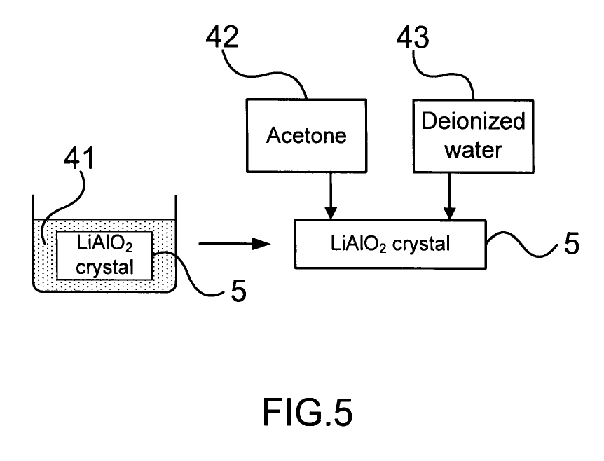

Please further refer to FIG. 5, which is a view showing the washing according to the preferred embodiment of the present invention. As shown in the figure, in the step of washing 4, the LiAlO₂ crystal 5 obtained after the three polishings 1,2,3 is soaked in a phosphoric acid (H₃PO₄) solution (SHOWA, Chemical Co., LDT) for etching; an d then the LiAlO₂ crystal 5 is taken out to be washed away contaminations left on the surface with acetone 42 at first and with deionized water 43 later on. Thus, a roughness between 0.4 and 0.9 nm rms for the surface of the LiAlO₂ crystal is obtained where the phosphoric acid (H₃PO₄) solution 41 can be replaced with hydrochloric (HCl) acid, nitric (HNO₃) acid, sulfuric (H₂SO₄) acid, acetic (HCOOH) acid ir hydrofluoric (HF) acid to obtain a different roughness range.

LiAlO₂ crystal is the most closely lattice-matched (1.4%) substrate currently being considered for Ga N heteroeptiaxy. The c-parameter of lattice constant for LiAlO₂ is close to two times of a-parameter (0.6378 nm) of lattice constant for GaN, while the a-parameter of lattice constant for LiAlO₂ is basically a perfect match to c-parameter (0.5165 nm) of lattice constant for GaN. The a-c (100) plane of LiAlO₂ has the same atomic arrangement as the (10-10) prismatic face plane of

What is claimed is:

1. A method for polishing lithium aluminum oxide crystal, comprising steps of:
(a) a first polishing,
wherein a lithium aluinum oxide (LiAlO₂) crystal is polished on a surface of said LiAlO₂ crystal along a continuously changing direction by sequentially using siliconcarbides of a first grain-size sequence, a second grain-size sequence, a third grain-size sequence and a fourth grain-size sequence, coordinated with water;
(b) a second polishing,
wherein, after aluminum oxide (Al₂O₃) powders having various grain sizes of Al₂O₃ respectively are mixed with a deionized water to obtain Al₂O₃ powder solutions, said surface is polished along a the wurtztie structure. The mismatch of LiAlO₂ (100) and the plane (10-10) (‘M-plane’) of GaN is only between 1 to 2%. Additionally, smooth and clean LiAlO₂ (100) substrates is crucial to avoid the formation of GaN (0001), where defect density is lowered.
To sum up, the present invention is a method for polishing lithium aluminum oxide crystal, where a film-free and scratch-free surface of a lithium aluminum oxide crystal is obtained with a roughness below 1.0 nanometer root-mean square.
The preferred embodiment herein disclosed is not intended to unnecessarily limit the scope of the invention. Therefore, simple modifications or variations belonging to the equivalent of the scope of the claims and the instructions disclosed herein for a patent are all with in the scope of the present invention. continuously changing direction by a grinder/polisher machine coordinated with said Al₂O₃ powder solutions;
(c) a third polishing,
wherein said surface is polished along a continuously changing direction by said grinder/polisher machine coordinated with a suspension of colloidal silica; and
(d) a washing,
wherein said LiAlO₂ crystal is soaked in an acid solution of phosphoric acid at a room temperature for a predestined time, and then said LiAlO₂ crystal is washed with acetone followed with a deionized water to be washed away contaminations on said surface to obtain a roughness between 0.4 and 0.9 nanometer (nm) root-mean square (rms) for said surface.

2. The method according to claim 1, wherein said first grain-size sequence is 800.

3. The method according to claim 1, wherein said second grain-size sequence is 1000.

4. The method according to claim 1, wherein said third grain-size sequence is 2000.

5. The method according to claim 1, wherein said fourth grain-size sequence is 4000.

6. The method according to claim 1 wherein said first polishing is processed with said siliconcarbides for a time between 40 and 50 minutes (min).

7. The method according to claim 1, wherein said Al₂O₃ powders comprises said grain sizes of 1 μm, 0.3 μm and 0.05 μm.

8. The method according to claim 1, wherein said grinder/polisher machine has a rotation speed between 150 and 200 revolutions per minute (rpm).

9. The method according to claim 1, wherein said second polishing is processed with said Al₂O₃ powders sol it ion for a time between 30 and 40 min.

10. The method according to claim 1 wherein said colloidal silica has a preferred grain size of 0.04 μm.

11. The method according to claim 1, wherein said third polishing is processed for a time between 20 and 30 min.

12. The method according to claim 1, wherein said acid solution is a solution of an acid further selected from a group consisting of hydrochloric (HCl) acid, nitric (HNO₃) acid, sulfuric (H₂SO₄) acid, acetic (HCOOH) acid and hydrofluoric (HF) acid.
